(19) United States
(12) Patent Application Publication
(10) Pub. No.: US 2016/0139275 A1
(43) Pub. Date: May 19, 2016

(54) ADVANCED CRYOSTAT DESIGN FOR RADIATION DETECTION

(71) Applicant: Advanced Measurement Technology Inc., Oak Ridge, TN (US)

(72) Inventor: Joseph B. McCabe, Oak Ridge, TN (US)

(21) Appl. No.: 14/540,448

(22) Filed: Nov. 13, 2014

(51) Int. Cl. G01T 1/16; G01T 7/00

(52) U.S. Cl. CPC G01T 1/16; G01T 7/00

(57) ABSTRACT

A structurally robust radiation detection system is provided, the system having a radiation detector, a first encasement encasing the radiation detector, a second encasement encasing the first encasement, and a pair of rigid support frames each configured to couple the first encasement to the second encasement such that the first encasement does not contact the second encasement, the support frames respectively comprising an inner ring configured to be coupled to the first encasement, an outer ring configured to be coupled to the second encasement, and a plurality of curvilinear connecting members connecting the inner ring to the outer ring, the connecting members being periodically spaced apart along a circumference of each of the inner and outer rings and respectively configured to have connecting points at the inner ring that are radially offset from corresponding connecting points at the outer ring.

### FIELD OF INVENTION

The present general inventive concept relates to radiation detectors, and, more particularly, to a structurally robust support frame for a radiation detector encasement.

### BACKGROUND

Due to its far superior resolution, high purity germanium HPGe is the preferred radiation detection technology to provide sufficient information to accurately and reliably identify radionuclides from their passive gamma ray emissions. The presence of naturally occurring radioactive material (NORM) creates a situation in which false positives (nuisance alarms) are highly probable. This directly makes our ability to interdict illicit radiological and nuclear materials before they do harm much more challenging. HPGe, due to its excellent energy resolution, is also much more effective than scintillation based detectors in the detection and identification of special nuclear material (SNM).

HPGe detectors have been used for over a quarter of a century. However, because they are required to operate at cryogenic temperatures and require highly accurate supporting electronics, HPGe detectors have historically been used as large and expensive laboratory instruments, and not very suitable for field use.

Recently, two advances in technology have revolutionized the applications of HPGe for the use of radiation detection and identification. First, advances in solid-state electronics and particularly in digital signal processing over the past ten years have dramatically reduced the size, complexity, operating power, and cost of the electronics required to support HPGe detectors. Second, and much more recently, miniature, low-power, high reliability cryogenic coolers have been developed that replace liquid nitrogen as the cooling mechanism.

In the design of radiation detection systems incorporating HPGe as a detector, conventional attempts at improving the thermal loading associated with cryostat designs including multiple encapsulation chambers have focused on structures that incorporate low conductive materials such as KEVLAR strings in a ‘tie-down’ configuration. These approaches are effective at providing a ‘sling’ approach to suspend the detector (and immediate encasement) but do not address the robust/ruggedness requirements of field deployment (including Homeland Security missions and first responder applications). Requirements in these applications require drop testing, shock & vibration testing, and long term reliability capability.

### BRIEF SUMMARY

The present general inventive concept, in various example embodiments, includes a structurally robust, rigid support frame to be used in a radiation detection system to couple a first encasement encasing a radiation detector to a second encasement encasing the first encasement.

Additional aspects and advantages of the present general inventive concept will be set forth in part in the description which follows, and, in part, will be obvious from the description, or may be learned by practice of the present general inventive concept.

Various example embodiments of the present general inventive concept may provide a radiation detection system including a radiation detector, a first encasement encasing the radiation detector, a second encasement encasing the first encasement, and a pair of rigid support frames each configured to couple the first encasement to the second encasement such that the first encasement does not contact the second encasement, the support frames respectively including an inner ring configured to be coupled to the first encasement, an outer ring configured to be coupled to the second encasement, and a plurality of curvilinear connecting members connecting the inner ring to the outer ring, the connecting members being periodically spaced apart along a circumference of each of the inner and outer rings and respectively configured to have connecting points at the inner ring that are radially offset from corresponding connecting points at the outer ring.

The inner rings of the support frames may be coupled to respective ends of the first encasement.

The ends of the first encasement may be configured to have at least one raised portion to contact the inner rings of the support frames.

A plurality of through holes may be respectively provided to the inner and outer rings to receive securing members to couple the inner rings to the first encasement and the outer rings to the second encasement, and the raised portions of the ends of the first encasement may be configured with receiving portions corresponding to the through holes of the inner rings to receive the securing members that couple the inner rings to the first encasement.

A plurality of through holes may be respectively provided to the inner and outer rings to receive securing members to couple the inner ring to the first encasement and the outer ring to the second encasement.

The second encasement may be configured to have a stepped surface proximate to both ends of the first encasement to receive the securing members that couple the outer rings to the second encasement.

The outer ring may include one or more lip portions extending perpendicularly in at least one direction from the support frame, the through holes provided to the outer rings being configured on the one or more lip portions to secure the support frame to an inner surface of the second encasement.

The inner ring may be concentric to the outer ring.

The radiation detector may include high purity germanium.

Various example embodiments of the present general inventive concept may provide a support frame to be used in a radiation detection system to couple a first encasement encasing a radiation detector to a second encasement encasing the first encasement, the support frame including an inner ring configured to be coupled to the first encasement, an outer ring configured to be coupled to the second encasement, and a plurality of curvilinear connecting members connecting the inner ring to the outer ring, the connecting members being periodically spaced apart along a circumference of each of the inner and outer rings and respectively configured to have connecting points at the inner ring that are radially offset from corresponding connecting points at the outer ring.

The support frame may be configured to couple the first encasement to the second encasement such that the first encasement does not contact the second encasement.

A plurality of through holes may be respectively provided to the inner and outer rings to receive securing members to couple the inner rings to the first encasement and the outer rings to the second encasement.

The outer ring may include one or more lip portions extending perpendicularly in at least one direction from the support frame, the through holes provided to the outer rings being configured on the one or more lip portions to secure the support frame to an inner surface of the second encasement.

The inner ring may include one or more raised portions extending perpendicularly from the support frame to contact the first encasement, the through holes provided to the inner ring being provided through the one or more raised portions.

The inner ring may be concentric to the outer ring.

Other features and aspects may be apparent from the following detailed description, the drawings, and the claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a graph of gamma-ray spectra of natural background illustrating a comparison of natural background radiation as collected by four different types of radiation detectors;

FIG. 2 is a graph illustrating radioactive material fingerprints of two example materials viewed with a select few various detector types;

FIG. 3 illustrates a support frame to be used in a radiation detection system according to an example embodiment of the present general inventive concept;

FIG. 4 illustrates a cross section of a portion of a radiation detection system using the support frame illustrated in FIG. 3 according to an example embodiment of the present general inventive concept;

FIG. 5 illustrates a three dimensional view of the cross section of the portion of the radiation detection system illustrated in FIG. 4; and

FIG. 6 illustrates a support frame according to another example embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Gamma-ray spectroscopy has proven to be a successful and efficient tool in support of nuclear safeguards for its ability to conclusively identify and quantify special nuclear material (SNM). This is due to the fact that each radioisotope emits radiation (e.g., gamma rays) at unique and discrete energies. Accordingly, the excellent energy resolution capability of HPGe, and its subsequent ability to differentiate between the discrete energies of the impinging gamma rays, affords HPGe an unparalleled ability to differentiate between legitimate and illicit materials. The challenge that has confronted the industry, as well as the Department of Energy, Department of Defense, DTRA, and the DNDO concerning the use of HPGe includes the device packaging; specifically overall weight and geometry. One aspect of the present general inventive concept is concerned with developing the technologies and techniques that are valuable in significantly advancing the current state-of-the art in HPGe Radio-Isotope Identification Detector (RIID), Backpack-based Radiation Detection Systems (BRDS), Man-portable, Radiation Detection Systems (MRDS), Portal/Cargo Screening Application, etc., as well as all additional radiation (nuclear) detection and identification applications.

HPGe based gamma-ray spectrometers offer the best resolution of any comparable technology. This level of resolution positions HPGe as the premier identification technology when distinguishing between isotopes (even in the presence of high backgrounds) is required. HPGe is the radiation detection technology that best provides sufficient information to accurately and reliably identify radionuclides from their passive gamma ray emissions, especially nuclear threat sources that have been shielded or masked to avoid detection. Masking, in general terms, represents the situation in which one radioisotope energy is ‘masked’ by the energy of another radioisotope. Shielding, in general terms, represents the situation in which a radioisotope material is placed within a shield (e.g., lead) in order to prohibit the radiation (e.g., gamma ray) from leaving the enclosure. HPGe detectors have proven in numerous independent government tests to be far superior to all other detection systems in mixed isotope, shielded, stand-off, and high background scenarios. Whether in a secondary detection role providing portable positive identifications of radiation sources in response to gross radiation alarms, or used in a search scenario or a choke point monitor to check for various rad/nuke sources, HPGe is the best available technology and is referred to as “the gold standard”.

Due to the prevalence of naturally occurring radioactive material (NORM) present in legitimate commerce, items such as ceramic tiles and fertilizer, along with radionuclides used in industrial or medical applications, can cause gross monitors to “alarm” quite often. This type of “false positive” is actually not a true false positive because the material is indeed radioactive. These alarms caused by NORM or legitimate radioisotopes are frequently referred to as nuisance alarms, because they inhibit the flow of legitimate commerce. Many of these nuisance alarms require some type of action to resolve the alarm. If vehicles, packages, or people were stopped every time an increased radiation level was detected, commerce would be halted and the resulting negative economic impact would be huge.

When an alarm is triggered, response personnel must be able to quickly ascertain if the alarm was caused by a legitimate commercial radioactive source, a NORM, an industrial or medical isotope, or a potential terrorist threat. To determine the identity of the radioactive source, it is necessary to do a spectroscopic analysis of the suspicious package, cargo container, or vehicle that caused the alarm. All radioactive materials emit unique gamma energies that are conceptually similar to “fingerprints.” These emissions can be analyzed to determine exactly what type of radioactive material is present.

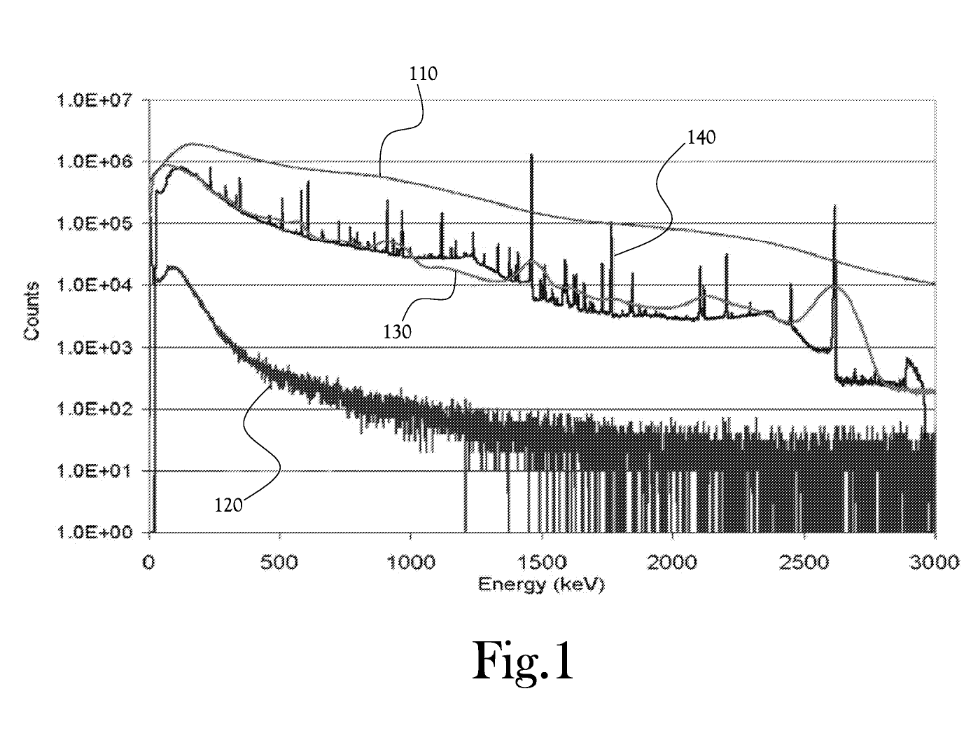

FIG. 1 is a graph of gamma-ray spectra of natural background illustrating a comparison of natural background radiation as collected by four different types of radiation detectors. Plastic scintillator detectors, illustrated by 110 in FIG. 1, has very limited ability to resolve gamma peaks, and therefore lack the needed resolution. Cadmium zinc telluride (CZT) and sodium iodide (NaI) detectors, illustrated by 120 and 130 respectively in FIG. 1, have limited abilities to resolve the gamma lines, due at least to the very poor efficiency of the CZT detector and the poor resolution of the NaI detector. As a detector, High Purity Germanium (HPGe), illustrated by 140 in FIG. 1, has high resolution ability, and operates at an excellent level of efficiency. Resolution, in the aforementioned example, is typically communicated as the full width half max (FWHM) of the respective energy level at a particular gamma energy.

Every radionuclide naturally emits a unique set of one or more gamma ray energies from which it can be uniquely identified, not unlike a fingerprint uniquely identifies an individual person. These energies are measured in units of electron volts (eV) or Kilo-electron volts (KeV) and most are found within the range of 30 keV to 3000 keV. They are not however uniformly spread across this aforementioned range. Many are tightly spaced with only a few keV or less between them. To make identifications accurately, one needs to be able to measure these energies to less than 2/10th of 1 percent. HPGe detectors can provide this level of accuracy, while NaI detectors provide only about 7-8% and LaBr3 about 3%. This problem is obvious when you look at the comparable spectra produced by NaI and HPGe detectors.

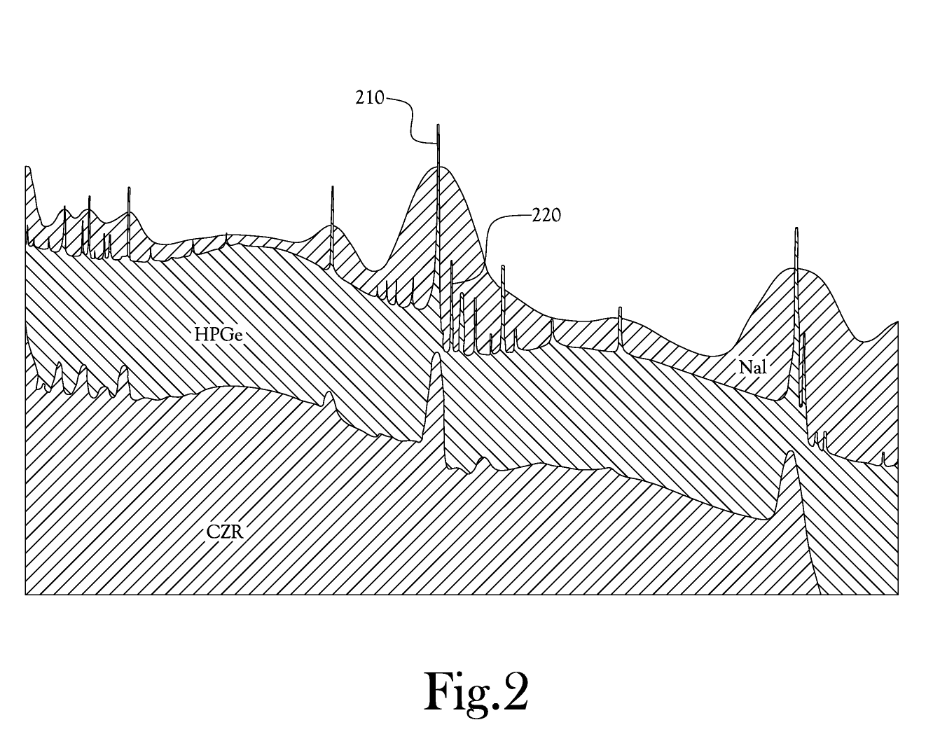

FIG. 2 is a graph illustrating radioactive material fingerprints of two example materials viewed with a select few various detector types. More specifically, FIG. 2 illustrates a comparison of three “fingerprints” of two types of radioactive material (plutonium and iodine) captured using a low resolution NaI detector (Blue), a medium resolution detector CZT (Black), and a high resolution HPGe detector (Red). This is one particular example of how one particular SNM (plutonium) can be ‘masked’ by another more commonly occurring radioactive material (iodine).

The “peaks” in these graphs represent the unique “fingerprints” of the two radioactive materials (plutonium and iodine). The respective gamma energies from iodine 210 and plutonium 220 are very close to one another. However, in the NaI and CZT graphs, they appear as one peak, whereas in the HPGe graph the peaks are clearly distinguishable. The NaI and CZT systems are unable to find the dangerous nuclear material (plutonium) shipped in a package that also contained a legal shipment of a medical isotope (iodine). A real world example of this scenario occurred with several vessels that passed through the Fukashima plume after the reactor accident in Japan. Material on these vessels had become contaminated with Iodine, and lower resolution detection systems frequently identify Iodine as weapons grade plutonium.

Scintillation detection systems based on PVT or NaI detectors provide only a rough approximation (analogous to a smudged fingerprint) of the energies emitted from a radioactive source, and very often will misinterpret or incorrectly analyze the radioactive materials. As demonstrated in FIG. 2, low-resolution detectors would have difficulty identifying the presence of Special Nuclear Material (SNM) that has been hidden inside one of the thousands of legal radioactive shipments occurring every day. The resolution problems will accompany NaI technology in whatever setting it is used (such as a RIID or portal monitor).

In testing over the past several years, low resolution systems were not capable of satisfying the minimum requirements of identifying shielded radioactive materials (ITRAP, .Illicit Trafficking Radiation Detection Assessment Program., Final report, ARC Seibersdorf. February, 2001). Other systems have attempted to use Cadmium Zinc Telluride (CZT) detectors to identify radiological materials, but these “medium resolution” detectors are very small (typically 15 mm×15 mm×7 mm), and they are therefore very inefficient. Count times using a CZT based detector would be orders of magnitude longer than NaI or HPGe detectors. Time is of the essence in performing analysis of an unidentified radioactive source. It is simply not feasible to perform a measurement that may last an hour or longer and still be unable to provide a definitive answer.

The present general inventive concept moves forward with another significant advancement in the area of photon detection (including radiation and nuclear detection and identification). Other attempts at improving the thermal loading associated with cryostat designs have focused on radiation detection structures with multiple encapsulation chambers that incorporate low conductive materials such as KEVLAR strings in a ‘tie-down’ configuration. These approaches are effective at providing a ‘sling’ approach to suspend the detector (and immediate encasement) but do not address the robust/ruggedness requirements of field deployment (including Homeland Security missions). Requirements in these applications require drop testing, shock & vibration testing, and long term reliability testing. The present general inventive concept provides a significant advancement in photon detection and identification by addressing the stringent thermal and mechanical/structural requirements of the Homeland Security Mission (and all other missions where ruggedness and high performance are required), while simultaneously minimizing the associated heat load.

Various examples of the present general inventive concept include a structurally robust, rigid support frame to be used in a radiation detection system to couple a first encasement encasing a radiation detector to a second encasement encasing the first encasement. Various example embodiments of the present general inventive concept discussed herein are described for the purpose of illustrating the general principles of the general inventive concept, and are not meant to limit the inventive concepts in any way.

Unless otherwise specifically defined herein, all terms are to be given their broadest possible interpretation including meanings implied from the specifications as well as meanings understood by those skilled in the art and/or as defined in dictionaries, treaties, etc.

Various example embodiments of the present general inventive concept described herein include a photon (radiation/nuclear) detector assembly as a radiation detection system, including HPGe as a radiation detector, the radiation detector being enclosed in an inner encasement for cooling purposes, and an outer encasement for further cooling of the enclosed inner encasement and radiation detector. In the example embodiments described herein, the cooling encasements are cryostat devices, but the present general inventive concept is not limited to such structures.

Various example embodiments of the present general inventive concept described herein include a photon (radiation/nuclear) detector assembly that includes a detector (example embodiments thereof may include high purity germanium), a structurally robust support frame, which may be referred to as a detector master structure, and one or more encasements. In the context of the embodiments described herein, a radiation detector may refer to any detector capable of detecting radiation.

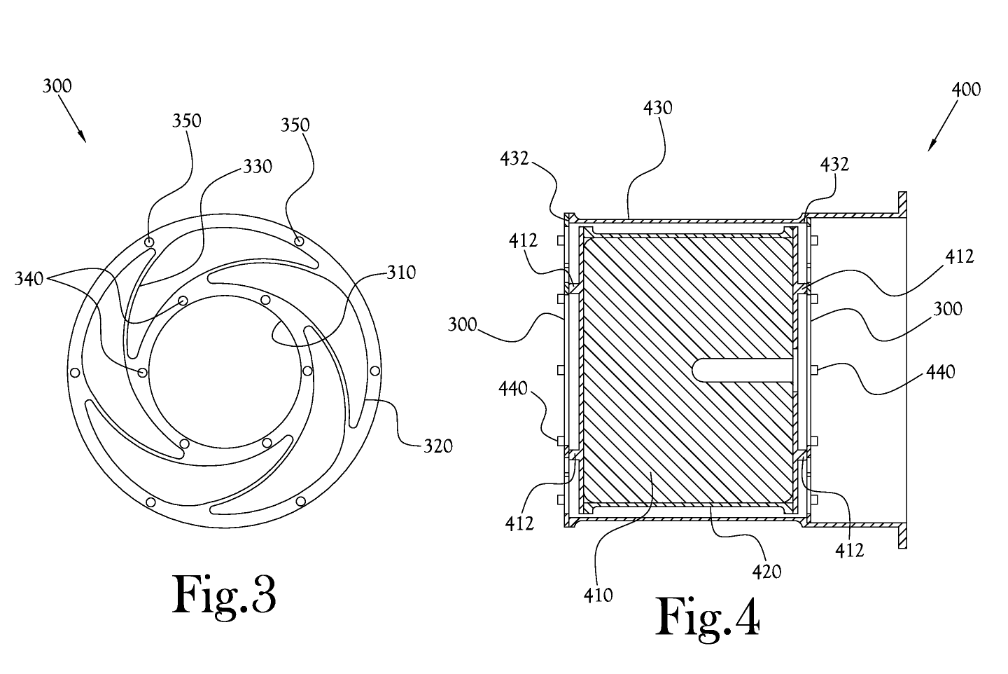

FIG. 3 illustrates a support frame to be used in a radiation detection system according to an example embodiment of the present general inventive concept. The support frame 300 is configured to couple a first encasement encasing a radiation detector to a second encasement encasing the first encasement, the configuration of which will be described in more detail herein. The support frame 300 includes an inner ring 310 configured to be coupled to the first encasement, an outer ring 320 configured to be coupled to the second encasement, and a plurality of curvilinear connecting members 330 connecting the inner ring 310 to the outer ring 320. As illustrated in FIG. 3, the connecting members 330 are circumferentially spaced apart at periodic intervals, and respectively configured to have connecting points at the inner ring 310 that are radially offset from connecting points at the outer ring 320. In example embodiments of the present general inventive concept described herein, “radially offset” indicates that two corresponding connecting points do not each lie on a radial line from the inner ring 310 to the outer ring 320. In other words, if a connecting member 330 is connected to a particular point on the inner ring 310, the point at which that connecting member 330 is connected to the outer ring 320 will not be along the radial line extending from the inner ring 310 to the outer ring 320. Such a configuration of the connecting members 330 provides a longer conduction path between the inner ring 310 and the outer ring 320 than would be provided if the connecting members simply extended outwardly from the inner ring 310 in a radial direction, and thus provide lower thermo-conductivity between the inner ring 310 and the outer ring 320, and therefore between the first and second encasements coupled to the support frame 300. Various example embodiments of the present general inventive concept may provide any number of connecting members 330, which may or may not be of a common size, length, thickness, etc.

The support frame 300 is configured to be a rigid structure, and therefore better maintains the position of the first encasement relative to the second encasement, which will be described in more detail herein. The support frame may be made with any of a host of materials, or combinations thereof, and may vary in thickness according to various example embodiments.

According to various example embodiments, the inner ring 310 can be provided with a plurality of through holes 340 to receive securing members to couple the inner ring 310 to the first encasement. Likewise, the outer ring 320 can be provided with a plurality of through holes 350 to receive securing members to couple the outer ring 320 to the second encasement. It is understood that providing through holes to receive securing members, such as, for example, screws, rivets, etc., is merely one example of a way in which the support frame 300 may be coupled to the respective encasements. Other various example embodiments may use other adhering/coupling methods or devices to achieve such a coupling.

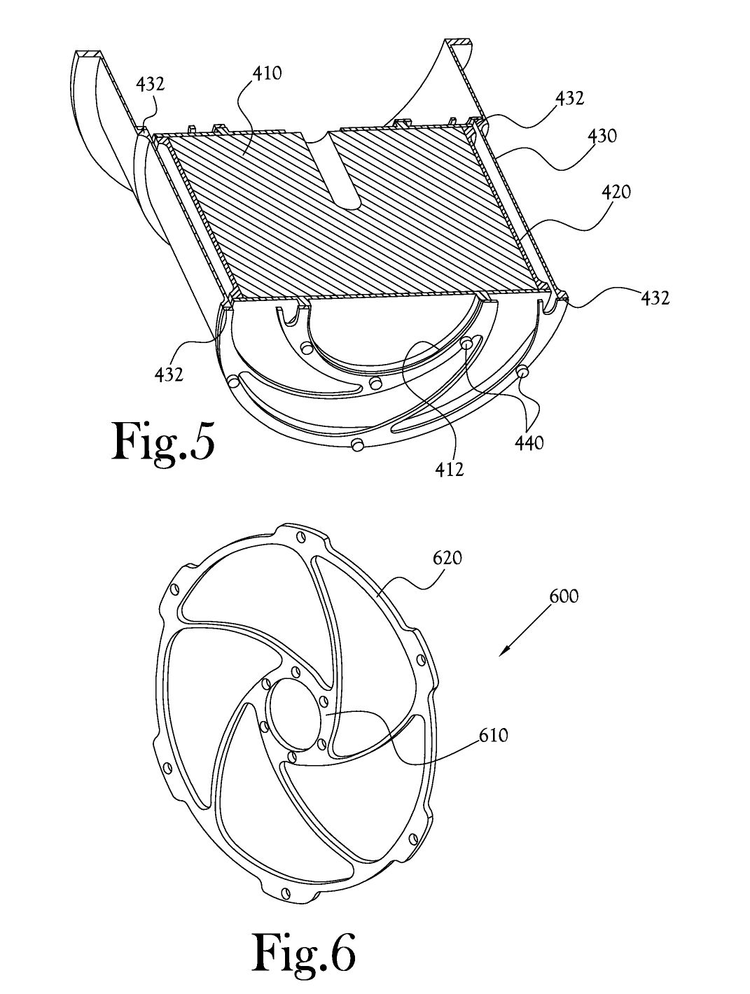

FIG. 4 illustrates a cross section of a portion of a radiation detection system using the support frame illustrated in FIG. 3 according to an example embodiment of the present general inventive concept, and FIG. 5 illustrates a three dimensional view of the cross section of the portion of the radiation detection system illustrated in FIG. 4. The example embodiment of the radiation detection system 400 illustrated in FIG. 4 includes a radiation detector 410 (HPGe in this example embodiment), a first encasement 420 encasing the radiation detector 410, a second encasement 430 encasing the first encasement 420, and a pair of rigid support frames 300 each configured to couple the first encasement 420 to the second encasement 430 such that the first encasement 420 does not contact the second encasement 430, the support frames 300 respectively including the inner ring 310 configured to be coupled to the first encasement 420, the outer ring 320 configured to be coupled to the second encasement 430, and the plurality of curvilinear connecting members 330 connecting the inner ring 310 to the outer ring 320 such that a gap is maintained between the first encasement 420 and the second encasement 430. Because the connecting members 330 are curvilinear and circumferentially spaced apart at periodic intervals and respectively configured to have connecting points at the inner ring that are radially offset from connecting points at the outer ring, a superposition of force vectors operating on the radiation detector may be avoided. For example, if a jarring force is directly incident to the second encasement 430, and therefore transferred to the support frame 300, the curvilinear configuration of the connecting members 330 will allow at least partial dispersal of the incident force in directions other than directly in a radial direction to the radiation detector 410. This results in a much more robust radiation detector system, and one that is therefore more able to withstand the rigors of field use.

As shown in the example embodiment illustrated in FIGS. 4-5, the inner rings 310 of the support frames 300 can be coupled to respective ends of the first encasement 420. In this example embodiment, the inner rings 310 are coupled to the ends of the first encasement 420 by securing members 440 received through the through holes 340 to contact the first encasement 420. The ends of the first encasement 420 in this example embodiment are configured to have at least one raised portion 412 to contact the inner rings 310 of the support frames 300 and to receive the securing members. In this example embodiment, the raised portions 412 are in the shape of rings that correspond to the inner rings 310 of the support frames 300. In various other example embodiments, the inner rings 310 may be coupled directly to the ends of the first encasement 420 without such raised portions 412, or may be coupled to a side surface of the first encasement 420. In other various example embodiments, the inner rings 310 may be configured to have one or more raised portions extending perpendicularly from the support frame 300 to contact the first encasement 420 or a provided raised portion 412 of the first encasement 420, and may or may not receive securing members 440 to couple the inner rings 310 to the first encasement 420. Various example embodiments may include adhering the inner rings 310 to the first encasement 420 by other various adhering means.

In the example embodiment illustrated in FIGS. 4-5, the outer rings 320 of the support frames 300 are coupled to the inner surface of the second encasement 430 by securing members 440 received through the through holes 350 and the inner surface of the second encasement 430. As noted in the description of the coupling of the inner rings 310 to the first encasement 420, various example embodiments may provide other adhering methods to achieve this coupling. In the example embodiment of FIGS. 4-5, the second encasement 430 is configured with stepped inner surfaces 432 proximate to both ends of the first encasement 420 and to which the outer rings 320 are coupled by the securing members 440. In other various example embodiments the inner surface of the second encasement 430 may be continuous, and the outer rings 320 may include one or more lip portions extending perpendicularly in at least one direction from the support frame 300, the through holes 350 being configured on the one or more lip portions, to secure the support frame 300 to the continuous inner surface of the second encasement 430.

As illustrated in FIGS. 3-5, the inner ring 310 may be concentric to the outer ring 320. However, in various example embodiments, the rigid support frame 300 may be configured to have an inner ring 310 that is not concentric to the outer ring 320, and wherein the connecting members 330 still provide the rigidity to maintain the position of the first encasement 420 relative to the second encasement 430 with or without raised portions being provided to either of the encasements or the rings of the support frame 300.

FIG. 6 illustrates a support frame according to another example embodiment of the present general inventive concept. As illustrated in FIG. 6, the support frame 600 may have an inner ring 610 with a smaller diameter than that of the example embodiment illustrated in FIG. 3. Likewise, inner rings having a larger diameter may be provided in other various example embodiments. The outer ring 620 of the support frame 600 may be configured to have an uneven edge to provide more surface area at portions containing through holes. The number of through holes may vary according to various example embodiments, or the support frame may be coupled to radiation detector system encasements by other means/methods besides through holes. According to various example embodiments, support frames may have varying numbers of connecting members, and the connecting members may vary in size, thickness, material, etc., and may vary in length from a length barely longer than a radial distance between the inner and outer rings, to a length that is several times longer the radial distance between the inner and outer rings, according the desired configuration and/or desired displacement of forces which may be applied to the radiation detector system.

Various examples of the present general inventive concept include a structurally robust, rigid support frame to be used in a radiation detection system to couple a first encasement encasing a radiation detector to a second encasement encasing the first encasement in a manner in which the position of the first encasement relative to the second encasement is maintained. One valuable aspect of such a configuration is that the entire assembly is a single mechanically robust structure. In conventional detector structures, the inner assembly may be suspension mounted with flexible thread-like materials (e.g., KEVLAR thread). Such an approach is not robust in nature, having an NIST tested thermo-conductivity value larger than that provided by the present general inventive concept, and a much less secure relative positioning between encasements due to the suspension type mounting. The present general inventive concept avoids the published thermo-conductivity and suspension structure deficiencies of conventional supports such as KEVLAR by using materials high in mechanical strength (yield and tensile) and also low thermal conductivity. This delivers a structural design that is robust in nature, but also performs well from a thermal transfer perspective. This approach eliminates the robustness deficiencies of ‘suspension’ mounted designs seen in conventional applications.

It is noted that the simplified diagrams and drawings do not illustrate all the various connections and assemblies of the various components, however, those skilled in the art will understand how to implement such connections and assemblies, based on the illustrated components, figures, and descriptions provided herein, using sound engineering judgment.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A radiation detection system, comprising:
a radiation detector;
a first encasement encasing the radiation detector;
a second encasement encasing the first encasement; and
a pair of rigid support frames each configured to couple the first encasement to the second encasement such that the first encasement does not contact the second encasement, the support frames respectively comprising:
an inner ring configured to be coupled to the first encasement,
an outer ring configured to be coupled to the second encasement, and
a plurality of curvilinear connecting members connecting the inner ring to the outer ring, the connecting members being periodically spaced apart along a circumference of each of the inner and outer rings and respectively configured to have connecting points at the inner ring that are radially offset from corresponding connecting points at the outer ring.

2. The radiation detection system of claim 1, wherein the inner rings of the support frames are coupled to respective ends of the first encasement.

3. The radiation detection system of claim 2, wherein the respective ends of the first encasement are configured to have at least one raised portion to contact the inner rings of the support frames.

4. The radiation detection system of claim 3, wherein a plurality of through holes are respectively provided to the inner and outer rings to receive securing members to couple the inner rings to the first encasement and the outer rings to the second encasement; and
the raised portions of the ends of the first encasement are configured with receiving portions corresponding to the through holes of the inner rings to receive the securing members that couple the inner rings to the first encasement.

5. The radiation detection system of claim 1, wherein a plurality of through holes are respectively provided to the inner and outer rings to receive securing members to couple the inner ring to the first encasement and the outer ring to the second encasement.

6. The radiation detection system of claim 5, wherein the second encasement is configured to have a stepped surface proximate to both ends of the first encasement to receive the securing members that couple the outer rings to the second encasement.

7. The radiation detection system of claim 5, wherein the outer ring includes one or more lip portions extending perpendicularly in at least one direction from the support frame, the through holes provided to the outer rings being configured on the one or more lip portions to secure the support frame to an inner surface of the second encasement.

8. The radiation detection system of claim 1, wherein the inner ring is concentric to the outer ring.

9. The radiation detection system of claim 1, wherein the radiation detector comprises high purity germanium.

10. A support frame to be used in a radiation detection system to couple a first encasement encasing a radiation detector to a second encasement encasing the first encasement, the support frame comprising:
an inner ring configured to be coupled to the first encasement;
an outer ring configured to be coupled to the second encasement; and
a plurality of curvilinear connecting members connecting the inner ring to the outer ring, the connecting members being periodically spaced apart along a circumference of each of the inner and outer rings and respectively configured to have connecting points at the inner ring that are radially offset from corresponding connecting points at the outer ring.

11. The support frame of claim 10, wherein the support frame is configured to couple the first encasement to the second encasement such that the first encasement does not contact the second encasement.

12. The support frame of claim 10, wherein a plurality of through holes are respectively provided to the inner and outer rings to receive securing members to couple the inner rings to the first encasement and the outer rings to the second encasement.

13. The support frame of claim 12, wherein the outer ring includes one or more lip portions extending perpendicularly in at least one direction from the support frame, the through holes provided to the outer rings being configured on the one or more lip portions to secure the support frame to an inner surface of the second encasement.

14. The support frame of claim 12, wherein the inner ring includes one or more raised portions extending perpendicularly from the support frame to contact the first encasement, the through holes provided to the inner ring being provided through the one or more raised portions.

15. The support frame of claim 10, wherein the inner ring is concentric to the outer ring.
